(19) United States
(12) Patent Application Publication
(10) Pub. No.: US 2009/0265439 A1
(43) Pub. Date: Oct. 22, 2009

(54) E-MAIL REPEATER AND RELAY METHOD OF THE SAME

(76) Inventors: Koki Nakashiro, Atsugi (JP); Masahiko Nakahara, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/363,073

(22) Filed: Jan. 30, 2009

(30) Foreign Application Priority Data
Jan. 31, 2008 (JP) 2008-020633

(51) Int. Cl. G06F 15/16

(52) U.S. Cl. 709/206

(57) ABSTRACT

To grant an access permission to an attached file of an e-mail stored in a file server. An access permission to the attached file is set based on information included in a first e-mail. The attached file is stored in the file server. The second e-mail that is the first e-mail from which the added file is deleted and to which reference information for accessing the added file stored in the file server is added is transmitted to a receiver side mail server and a sender side mail server. In response to an access request to the attached file based on the reference information from either of a mail sender and a mail receiver, the file server controls the access to the attached file based on an access permission that was set.

### INCORPORATION BY REFERENCE

This application claims priority based on a Japanese patent application, No. 2008-020633 filed on Jan. 31, 2008, the entire contents of which are incorporated herein by reference.

### BACKGROUND OF THE INVENTION

The present invention relates to an e-mail repeater that stores a file attached to an e-mail in a file server and relays it by putting a link destination to the file into the e-mail, and a relay method thereof.

When sending a file by an e-mail, there is a method for sending the e-mail with the file attached thereto. In this method, since an attached file is duplicated for every sending destination of the e-mail, there is a method whereby the attached file is separated from the mail, is moved to on the file server, and is treated as a shared file due to reasons of problems of shortage of a disk capacity etc. When treating this attached file as the shared file, in order to determine who can access it, there is a method whereby an access permission is set using an address of the e-mail (e.g., Japanese Unexamined Patent Application Publication No. 2002-342249, hereinafter referred to as Document 1).

### SUMMARY OF THE INVENTION

In the case where information of destinations of the mail is used in setting an access permission when an attached file is used as the shared file, as described in Document 1, if the destinations, as they are, are used as an accessible table, only a setup of a permission only to read uniformly or a setup of a permission to read and write, although with weakness in terms of security, becomes possible. For example, when the access permission is set as the permission only to read, the user who transmitted the attached file cannot alter a shared file on the file server. Therefore, the user who made transmission will transmit a mail attached newly with the attached file in order to update or add a document of the attached file. As a result, this method comes with existence of plural shared files that differ in updated and added parts and have mostly similar contents, which causes problems of shortage of a disk capacity of the file server and of difficulty for the sender to know which one is the latest version, and the like.

Each of the e-mail repeater and the relay method of the disclosed system couples to a sender side mail server for transmitting a first e-mail from a mail sender to a mail receiver and to a receiver side mail server for transmitting a second e-mail to the mail receiver, and has an e-mail conversion repeater and the file server. When a file is attached to the first e-mail, the e-mail conversion repeater sets an access permission to the attached file based on information included in the first e-mail, stores the attached file in the file server, deletes the attached file from the first e-mail, and transmits the second e-mail that is the first e-mail from which the attached file is deleted and to which reference information for accessing the attached file stored in the file server is added, to the receiver side mail server and the sender side mail server. In response to an access request to the attached file based on the reference information from either of the mail sender and the mail receiver, the file server controls the access to the attached file based on the access permission being set by the e-mail conversion repeater.

Other desirable modes of the e-mail repeater and the relay method of the disclosed system set different access permissions for the mail sender and the mail receiver, respectively.

Further other desirable modes of the e-mail repeater and the relay method of the disclosed system set an access permission that enables updating of the attached file as the access permission that is set for the mail sender.

Further other desirable modes of the e-mail repeater and the relay method of the disclosed system, when the mail sender updated the attached file, notify the mail receiver that the attached file has been updated.

Further other desirable modes of the e-mail repeater and the relay method of the disclosed system, in response to forwarding of the second mail to another user by the mail receiver, set the access permission to the attached file.

Further other desirable modes of the e-mail repeater and the relay method of the disclosed system set the access permission to the attached file based on information included in the e-mail and information indicating an access source of access request.

Further other desirable modes of the e-mail repeater and the relay method of the disclosed system specify that information included in the first e-mail for determining the access permission to the attached file is information about the mail sender and the mail receiver and information included in a text of the e-mail.

According to the teaching herein, the attached file to the mail can be designated as the shared file on the file server and the access permission to the file can be set being brought into correspondence with information of the mail, such as the mail sender and the mail receiver included in the mail information.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a block diagram showing an outline of a first embodiment.

FIG. 2 is an example of a configuration of an e-mail conversion repeater.

FIG. 3 shows an example of a configuration of an access management table.

FIG. 4 is an example of a configuration of a user authentication table.

FIG. 5 is one example of a processing flowchart of the e-mail conversion repeater.

FIG. 6 is an example of a configuration of a file server.

FIG. 7 is an example of a configuration of a file ID table.

FIG. 8 is one example of a processing flowchart of the file server.

FIG. 9 is another example of a configuration of the e-mail conversion repeater.

FIG. 10 is an example of a configuration of an access source management table.

FIG. 11 shows an example of a configuration of an access determination table.

FIG. 12 is one example of security specification by a mail text.

FIG. 13 is a concrete example of setup contents in the mail text.

FIG. 14 is an outline of disclosure of the attached file to a third person.

FIG. 15 is an example of a configuration of a forwarding prevention access management table.

FIG. 16 is an outline of encryption of a file on the file server.

FIG. 17 is an outline of notification at the time of updating the file.

### DETAILED DESCRIPTION OF THE EMBODIMENTS

Hereafter, best modes for carrying out the present invention will be explained using embodiments. In the explanation below, an e-mail is only called a mail.

### First Embodiment

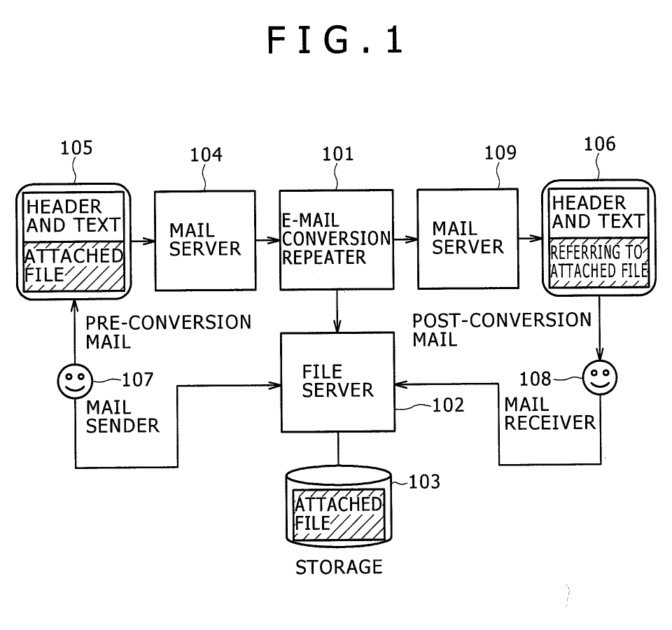

FIG. 1 is a block diagram showing an outline of a first embodiment. A mail sender 107 who transmits a pre-conversion mail 105 with an attached file requests a mail server 104 to transmit the mail. The pre-conversion mail 105 transmitted from the mail server 104 is separated by an e-mail conversion repeater 101 to give the attached file, and the attached file thus separated is stored in a storage (storage device) 103 through a file server 102. A post-conversion mail 106 such that the separated attached file is replaced with reference information of the file on the file server 102 is transmitted to a mail receiver 108 from the e-mail conversion repeater 101 via a mail server 109. The post-conversion mail 106 is transmitted also to the mail sender 107 via the mail server 104. Using the reference information to the attached file, the mail sender 107 or the mail receiver 108 accesses to the file server 102, and updates or peruses (refers to) the attached file.

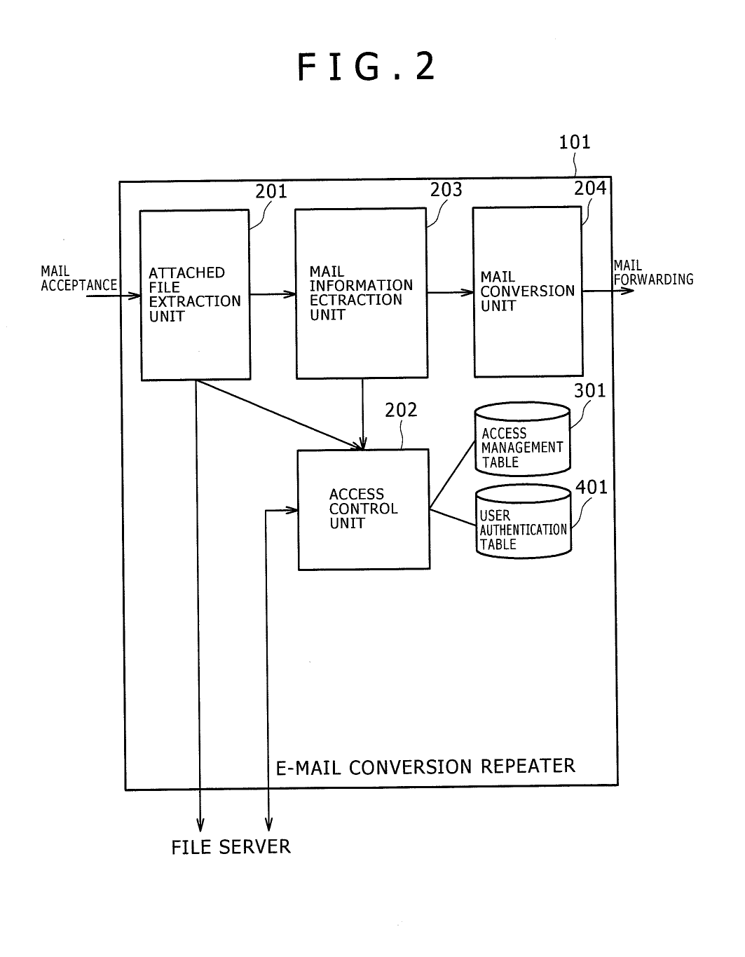

FIG. 2 shows an example of a configuration of the e-mail conversion repeater 101. The e-mail conversion repeater 101 has an attached file extraction unit 201 for extracting (separating) the attached file from the mail, a mail information extraction unit 203 for analyzing a destination etc. of the mail, an access control unit 202 for setting an access permission to the attached file, a mail conversion unit 204 for forming a mail such that the attached file is deleted from the mail and putting therein a storage location of the attached file on the file server instead, an access management table 301, and a user authentication table 401.

The attached file extraction unit 201 existing in the e-mail conversion repeater 101 extracts the attached file from the pre-conversion mail 105, and makes a request to the file server 102 for storage of the attached file. The attached file is deleted from the pre-conversion mail 105. The mail information extraction unit 203 analyzes the information of the mail 105, and forms the access management table 301. The mail conversion unit 204 transmits the post-conversion mail 106 into which the reference information of the attached file is put instead of the attached file of the mail to the mail server 109 and the mail server 104. The file server 102 stores the attached file in the storage, adds a file ID 302 to the stored attached file, and informs the ID 302 to the e-mail conversion repeater 101.

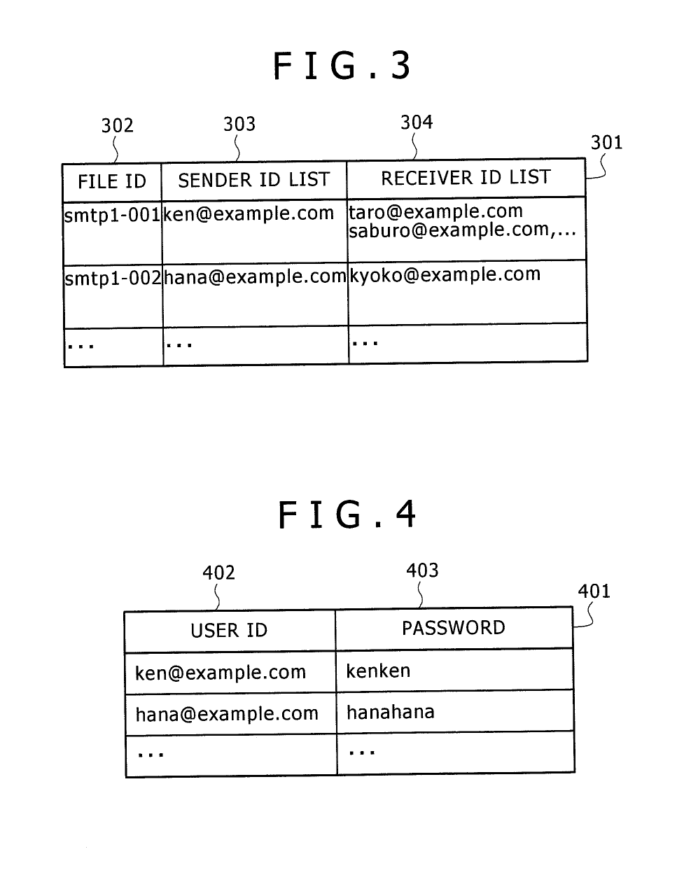

FIG. 3 shows the access management table 301. The access management table 301 maintains the file ID 302 of the attached file notified from the file server 102, and a sender ID 303 and a receiver ID list 304 such that the sender and the receiver have each the access permission to the attached file. In this embodiment, it is assumed that an access permission to read and write is set for the sender and one only to read is set for the receiver. Based on this access permission, any access to the attached file from the sender or the receiver is controlled.

FIG. 4 shows the user authentication table 401. The user authentication table 401 maintains a user ID 402 and its password 403 being brought into correspondence with each other. The contents of the user authentication table 401 are set up in advance accompanying a processing of separate user registration.

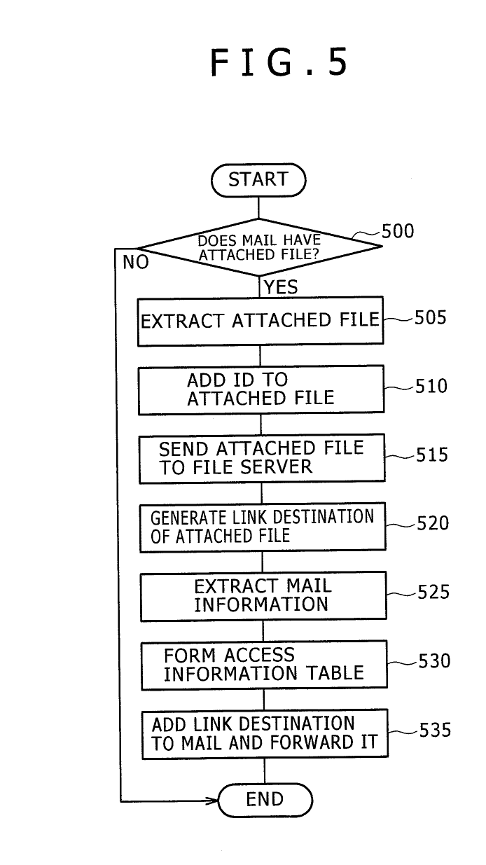

FIG. 5 is a processing flowchart of the e-mail conversion repeater 101. The e-mail conversion repeater 101 examines whether the mail 105 transmitted from the mail server 104 includes the attached file in the attached file extraction unit 201 thereof, and if there is no attached file, will transmit the mail 105, as it is, to the objective mail server 109 (Step 500). If there is the attached file, it will be extracted (separated) (Step 505) and a file ID 302 will be given to the file (Step 510). Ways to determine the file ID 302 at this time include a method whereby a sequence of the attached files included in the mail is added to the end of the mail ID with respect to the mail ID (Message-ID:) existing in a header of the mail, and the like.

Next, the attached file having been separated is sent to the file server 102 (Step 515). By sending the file ID 302 together with the attached file, the respective files are differentiated among them in the case where there are plural attached files. The reference information (link destination) to the attached file on the file server is formed (Step 520). The reference information is formed according to the kind of file server and a destination group of the mail. Next, information of the mail is extracted in a mail information extraction unit 203 (Step 525). The access control unit 202 forms an access management table 301 by setting the From: line of a header of the mail to the sender ID 303 and setting at least one destination included in the To: line to the receiver ID list 304 in a format corresponding to the file ID 302 (Step 530). Addition of a number representing a sequence of the attached file to the Message-ID:, a header of the mail that is determined uniquely on a mail basis, to the end of the file ID 302, creates a unique key in each file, which makes possible the above. Then, a mail that maintains a link destination of the attached file formed in the mail conversion unit 204 at Step 520 is transmitted to the mail server 109 and the mail server 104 (Step 535). Transmission of the mail to the mail server 104 is done in order that the sender recognizes the link destination (the reference information) of the attached file. By the processing described above, the attached file is stored in the file server 102.

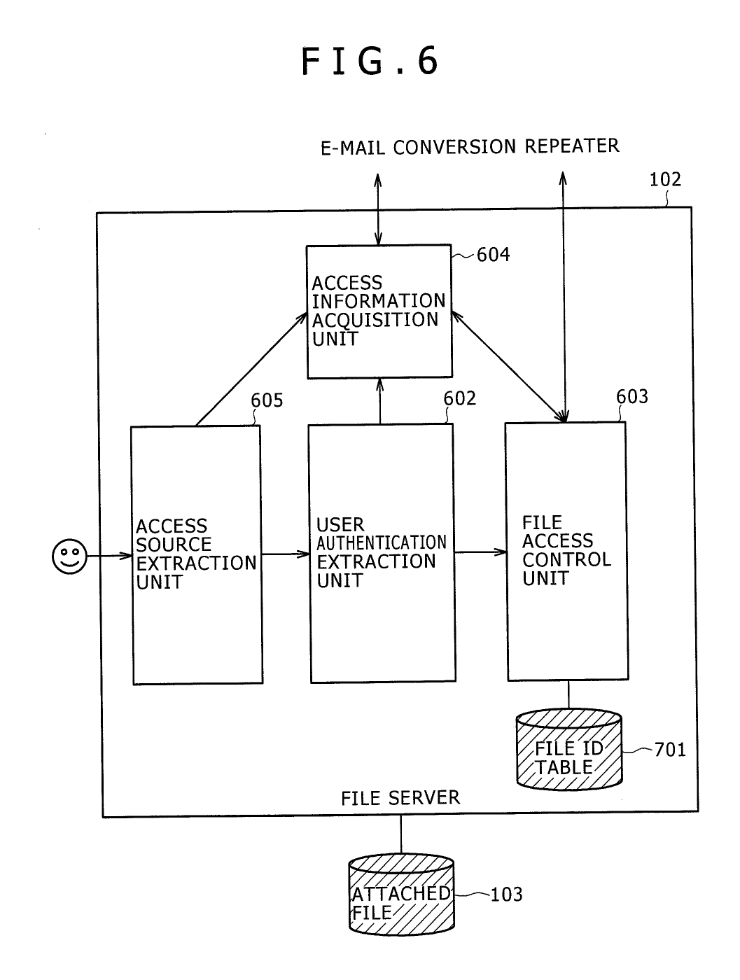

FIG. 6 shows an example of a configuration of the file server 102. The file server 102 has an access source extraction unit 605 for extracting an access source when the user has accessed, a user authentication extraction unit 602 for extracting authentication information of the user, a file access control unit 603 for controlling an access permission to a file, an access information acquisition unit 604 for exchanging access information between itself and the e-mail conversion repeater 101, and a file ID table 701.

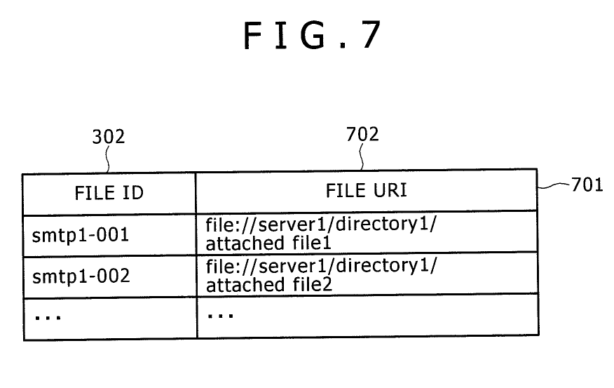

FIG. 7 shows the file ID table 701. The file ID table 701 maintains the file ID 302 determined uniquely to the attached file that was requested to be stored by the e-mail conversion repeater 101 and a file URI 702 that is the reference information (link destination) of the attached file on the file server 102.

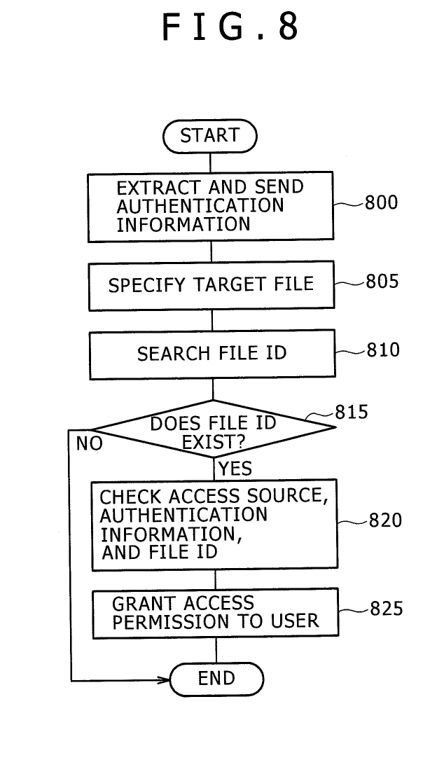

FIG. 8 is a processing flowchart of the file server 102 when the user accesses it. The access request from the user to the file server 102 accompanies the file user ID, a password, and a file URI for specifying a file that is an object of the access. When the user accesses to the file server 102, the file server 102 acquires authentication information, such as the user ID and the password, accompanying the access request, by the user authentication extraction unit 602 and sends it to the access information acquisition unit 604 (Step 800). Next, a target file that the user wishes to access is specified by the file URI 702 accompanying the access request (Step 805), and the file ID 302 corresponding to the file is searched using the file ID table 701 (Step 810). When the file ID 302 corresponding to the target file does not exist, the user having accessed is notified that the file is not found, and the processing is ended (Step 815). When the file ID 302 exists, the user ID 402 and the password 403 of the authentication information and the file ID 302 are sent to the e-mail conversion repeater 101. After the access control unit 202 in the e-mail conversion repeater 101 makes authentication of the user using the user authentication table 401, it acquires the access permission to the target file from the access management table 301 and returns it to the file access control unit 603 in the file server 102 (Step 820). The file access control unit 603 grants an access permission sent from the e-mail conversion repeater 101 to the user, permitting an access to the target file (Step 825).

Here, if the user ID of the sender agrees with the sender ID 303 of the attached file, the access permission to read and write is granted to an access of the sender and notifies the file server 102 of this, whereby the sender who is a user making the access request is enabled to update the attached file that is the target file. Moreover, when the receiver accesses the attached file as the target file, the receiver ID is referred to as in the receiver ID list 304 on the access management table 301, and consequently, the access permission to the attached file becomes one only to read. This difference in the access permission can provide an access permission in such a way that, when the user is the sender 107, the file can be updated, and when being the receiver 108, the file can only be read.

### Second Embodiment

In the first embodiment, the permission to read and write the attached file for the sender and a permission only to read the attached file for the receiver were granted using the transmission information of the mail. In this embodiment, in addition to this, the access permission is set using also information of the access source when the user accesses the file server. By this, the user accesses the attached file on the file server as the sender having the permission to read and write, but, for example, in the case where that user accesses the file server from outside the company, outside the company, a processing of not granting the permission to write etc. can be conducted because of giving priority to the access permission based on the information of the access source.

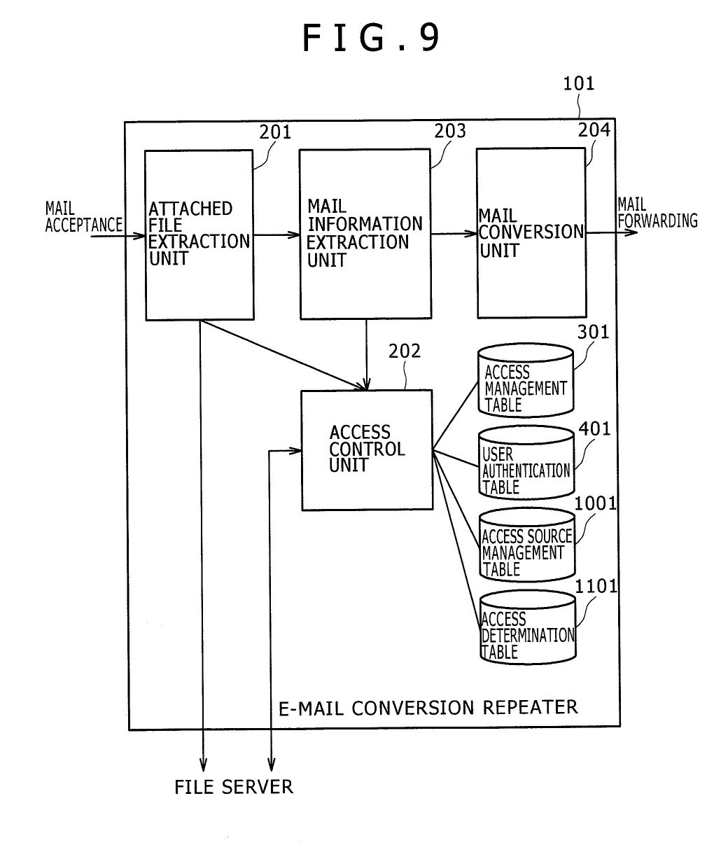

FIG. 9 shows a block diagram of the e-mail conversion repeater 101 of this embodiment. The e-mail conversion repeater 101 shown in FIG. 9 is with a configuration that is the configuration of the first embodiment shown in FIG. 2 added with an access source management table 1001 and an access determination table 1101.

FIG. 9 shows the access source management table 1001. The access source management table 1001 maintains the user ID 402 and access source information (e.g., IP address) 1003 being brought into correspondence with each other.

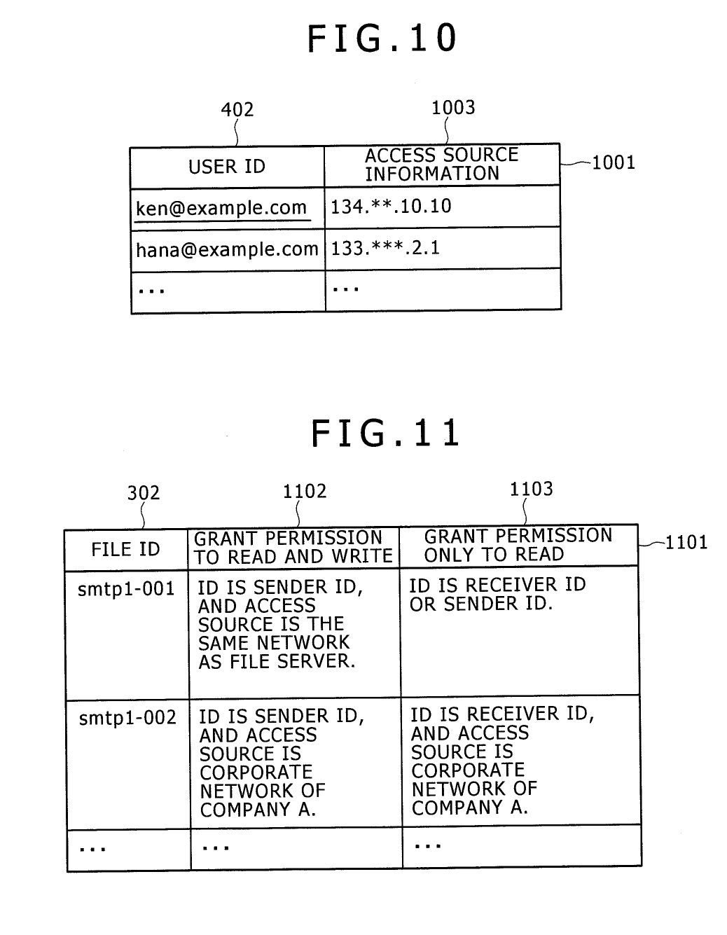

FIG. 10 shows the access determination table 1101. The access determination table 1101 maintains a condition of granting the permission to read and write 1102 and a condition of granting the permission only to read 1103 being brought into correspondence with the file ID 302.

Processing of storing an attached file portion of the mail with the attached file 105 into the file server 102 is conducted like the first embodiment, so that a state where the objective attached file exists on the file server 102 is realized. When there is an access to the attached file (target file) in the file server 102 by the user after that, the access source of the user is extracted (an IP address of a network from which the user accesses has been acquired in advance of Step 800 of FIG. 8 of the first embodiment). The access source information (IP address) is sent to the access control unit 202 together with the user's authentication information and the target file, and the access control unit 202 saves the user ID 402 and the access source information 1003 (IP address) as the access source management table 1001, as shown in FIG. 10. The access control unit 202 searches a file ID corresponding to the target file from the file ID 302 in the access determination table 1101, finds a condition of granting the permission to read and write 1102 and a condition of granting the permission only to read 1103 about the file ID 302, and determines what kind of access permission is granted.

For example, even when a certain file is an object of an access request from the user having the sender ID 303, if the system prohibits any accesses from an access source whose network is different from that of the file server 102, the condition of granting the permission to read and write 1102 is modified to be one that the user ID 402 having referred to the access source management table 1001 shall be the sender ID 303 and the access source information 1003 shall indicate the same network as that of the file server 102, as shown in FIG. 11. The condition 1103 of granting the permission only to read is that the user ID 402 is either of the receiver ID list 304 or the sender ID 303. When the sender ID 303 has accessed a certain file from a network different from that of the file server 102, the access source is different upon examination of the condition 1102 of granting the permission to read and write, the permission to read and write is not granted. However, the condition 1103 of granting the permission only to read is fulfilled, the access with the sender ID from the different network will become possible only for reading. The access permission can be determined using the access source information as described above.

### Third Embodiment

In this embodiment, the access is restricted by the mail information extraction unit 203 for extracting information of an e-mail acquiring transmission information of the mail and, in addition, by reading and using a specific format of a mail text.

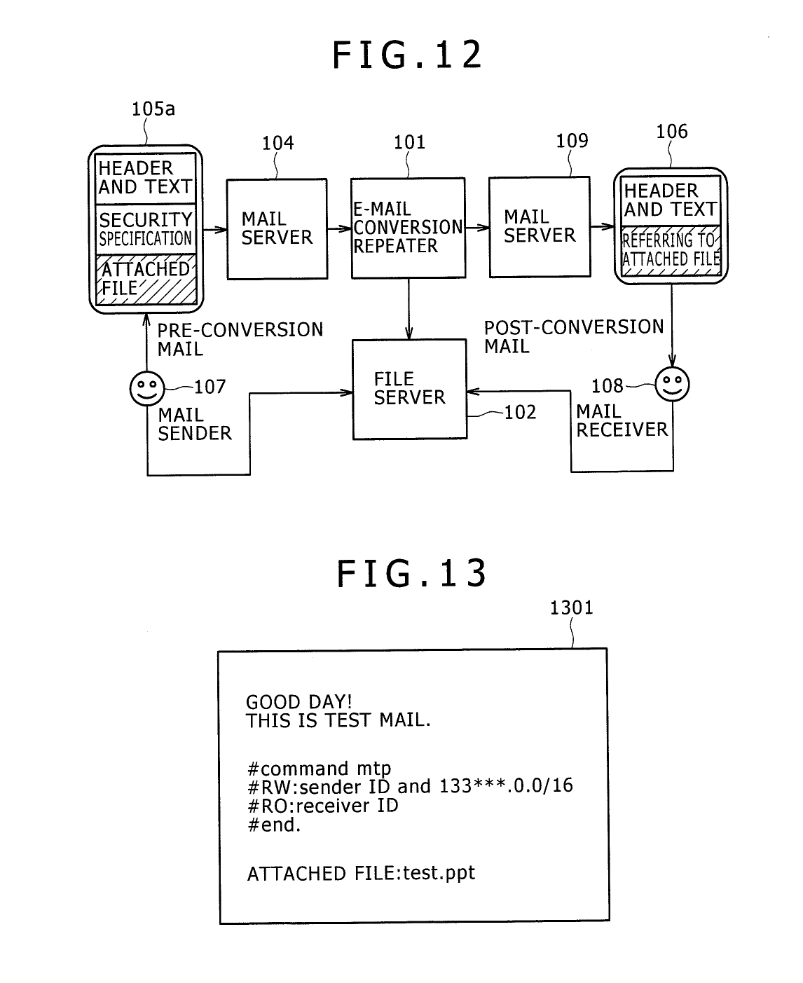

An example of the specific format of the mail text is shown in the pre-conversion mail 105a of FIG. 12 as security specification. FIG. 13 shows a concrete example of details of the format. As shown in FIG. 13, a statement using “#” in the text of a mail 1301 is prepared. # RW: represents the permission to read and write and #RO: represents the permission only to read. The sender ID represents the mail sender ID 303 and the receiver ID represents the mail receiver ID list 304. 133.144.0.0/16 represents IP addresses in a range of 133.144.0.0 to 133.144.255.255. The details of the specific format of this mail text are information to the mail information extraction unit 203, and are used for setting the access determination table 1101.

By setting the access determination table 1101 in this way, the condition 1102 of granting the permission to read and write becomes a condition: the user is the sender of the mail and at the same time is the user that is an access source having a network whose IP address is 133.144.0.0. Thus, it becomes possible to describe setup contents of the access determination table 1101 (FIG. 11) in the text of the mail and to set an access permission.

### Fourth Embodiment

This embodiment is an example to cope with a situation where a receiver B having received the post-conversion mail 106 wishes to show the attached file stored in the file server 102 to a user C not having received it. In a usual mail system where the attached file is not stored in the file server 102 (e.g., e-mail), this is supported by forwarding the mail.

Although usually the user C does not have the access permission to the file server 102, if file a policy on a file basis or of the system permits the attached file to be disclosed to the user specified by a direct receiver B, the user C is permitted to access to the file by the following method.

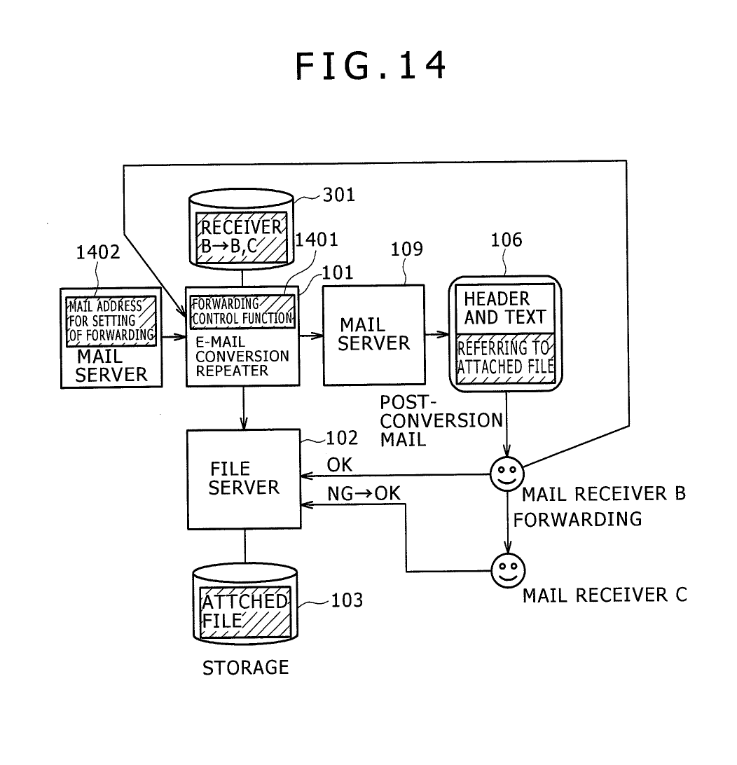

FIG. 14 shows an outline of disclosure of the attached file to a third person. As shown in FIG. 14, a mail address 1402 of a forwarding destination to which the receiver of the mail is permitted to forward it is prepared in the mail server 104 or like, and this mail address 1402 is transmitted to the e-mail conversion repeater 101 together with the mail. The e-mail conversion repeater 101 stores it in a storage device 1403 being brought into correspondence with the mail address of the receiver. The e-mail conversion repeater 101 does not transmit this mail address 1402 to the mail server 109. The following method may be adopted: a format by which the mail address 1402 like this is written in the pre-conversion mail 105 itself is prepared, and a part of the format is read by the e-mail conversion repeater 101 and is deleted from the pre-conversion mail 105 after the reading. The contents of the storage device 1403 of FIG. 14 indicate that the mail receiver B is permitted to disclose the attached file to the user C.

In order to disclose the attached file to the user C, the mail receiver B (the mail receiver 108 in FIG. 1) transmits the post-conversion mail 106 that was received as a forwarded mail having a destination specification that designates the user C as a mail receiver C and a destination specification that delivers the mail to the e-mail conversion repeater 101. The e-mail conversion repeater 101 having received the forwarded mail recognizes that it is a post-conversion mail in the mail information extraction unit 203 because the reference information to the attached file is included, and also checks that it is the forwarded mail because its destination is the e-mail conversion repeater 101. A forwarding control function 1401 of the e-mail conversion repeater 101 refers to the contents of the storage device 1403, checks that the mail is forwarded to the receiver C included in the destination of the received forwarded mail from the mail receiver B in order to disclose the attached file, and adds the receiver C as a receiver list of the access management table 301 through the access control unit 202. Now, the receiver C becomes able to access the file on the file server 102.

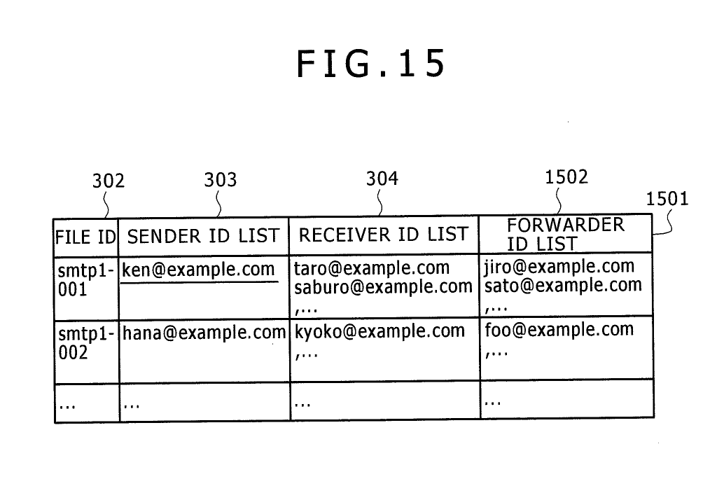

If the receiver C forwards it further, an access permission to the file can be granted to the other users. However, when restricting such re-forwarding, a forwarding prevention access management table 1501 shown in FIG. 15 is used. The forwarding prevention management table 1501 is an access management table 301 shown in FIG. 3 added with a column of a forwarder ID list 1502. For example, in order to configure the system to grant an access permission only at the time of forwarding from the receiver B, the receiver C is added to the forwarder ID list 1502, as shown in FIG. 15, not adding it to the receiver ID list 304 of the access management table 301. It is made not to permit the user of the re-forwarding destination from the user C included in the forwarder ID list to access the file on the file server 102.

### Fifth Embodiment

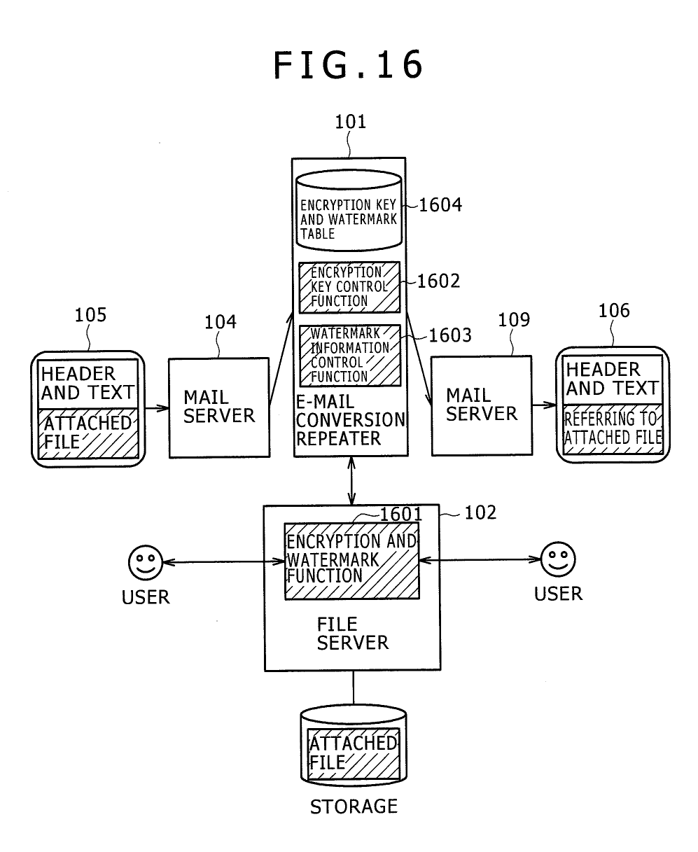

This embodiment is an example of enciphering the file on the file server 102 as a part of security countermeasures and its outline is shown in FIG. 16. In FIG. 16, first, users register their respective public keys in a cryptography key and watermark information table 1604 in advance. When the user accesses the file server 102, at the time of checking the user (Step 820) by extracting and sending (Step 800) its authentication information shown in the processing flow of FIG. 8, the public key inherent to the user is acquired from the cryptography key and watermark information table 1604 through a cryptography key control function 1602 in the e-mail conversion repeater 101. By providing the user a file that an encryption and watermark function 1601 enciphered using the public key as a file that the user is permitted to access, an encryption file function different for every user can be carried out.

In addition, when putting a watermark into an image file similarly, that watermark information is acquired by a watermark information control function 1603 in the e-mail conversion repeater 101 instead of the above-mentioned public key or that watermark information is given into the file server 102 makes possible the following: information as to what kind of watermark is to be put is acquired from the cryptography key and watermark information table 1604 through the encryption and watermark function 1601 and the encryption and watermark function 1601 puts the watermark into an image file that is accessible from the file server.

### Sixth Embodiment

When updating of the attached file, for example, on the file server 102 is permitted for the sender without any conditions or with a condition, if the attached file is updated, the receiver must be notified that it has been updated. If not being notified, there will occur a situation where the update of the attached file by the sender after the receiver referred to the attached file cannot be differentiated from falsification. This embodiment shows notification at the time of updating a file in order not to allow such a situation to occur.

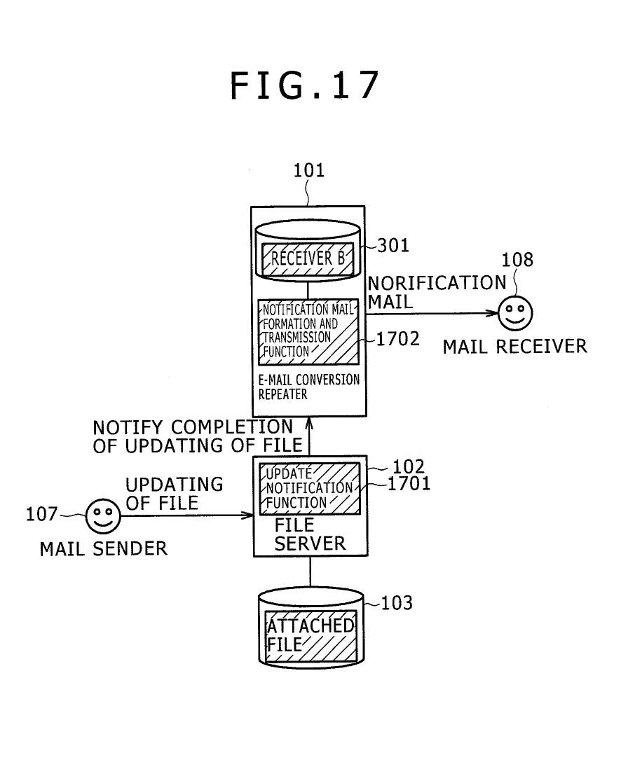

FIG. 17 shows an outline of notification at the time of updating the file. When the file on the file server 102 is updated by the user, such as the mail sender, who has the permission to read and write, the update is notified to the file server, or at a timing of noticing existence of the update by checking the update after the file server waited for a certain amount of time, an update notification function 1701 notifies the e-mail conversion repeater 101 of occurrence of the update together with the file ID 302 from the file server 102. A notification mail formation and transmission function 1702 in the repeater notifies the receiver of the occurrence of the update of the file by accessing the access management table 301, obtaining the receiver ID list 304 corresponding to the file ID 302, and forming and transmitting a mail for notifying the update using the receiver ID list 304 as a destination.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An e-mail repeater, comprising:
an e-mail conversion repeater that couples to a sender side mail server for transmitting a first e-mail from a mail sender to a mail receiver and a receiver side mail server for transmitting a second e-mail to the mail receiver and that, in the case where a file is attached to the first e-mail, sets an access permission to an attached file based on information included in the first e-mail, stores the attached file in a file server, deletes the attached file from the first e-mail, and sends the second e-mail made by adding reference information for accessing the attached file stored in the file server to the first e-mail from which the attached file is deleted to the receiver side mail server and the sender side mail server; and
the file server that couples to the e-mail conversion repeater and that, in response to an access request to the attached file based on the reference information from either of the mail sender or the mail receiver, controls the access to the attached file based on the access permission being set by the e-mail conversion repeater.

2. The e-mail repeater according to claim 1, wherein, based on information included in the first e-mail for specifying each of the mail sender of the first e-mail and the mail receiver of the second e-mail, a different access permission is set for each of the mail sender and the mail receiver.

3. The e-mail repeater according to claim 2, wherein the access permission that is set for the mail sender is a permission whereby the attached file can be updated.

4. The e-mail repeater according to claim 3, wherein, when the mail sender updated the attached file, the mail receiver of the second e-mail is notified that the attached file has been updated.

5. The e-mail repeater according to claim 2, characterized by, in response to forwarding of the second e-mail to an other user by the mail receiver of the second e-mail, setting the access permission to the attached file for the other user based on information that specifies the other user included in the second e-mail.

6. The e-mail repeater according to claim 5, wherein, in response to forwarding of the second e-mail to a further other user from the other user to whom the second e-mail was forwarded, the access permission to the attached file is not granted to the further other user included in the second e-mail.

7. The e-mail repeater according to claim 2, wherein, based on information indicating an access source of either one of the mail sender or the mail receiver that made the access request in addition to information included in the first e-mail, the access permission to the attached file is set.

8. The e-mail repeater according to claim 2, wherein information included in the first e-mail for determining the access permission to the attached file is information about the mail sender and the mail receiver included in the first e-mail and information included in a text of the first e-mail.

9. The e-mail repeater according to claim 2, wherein the e-mail conversion repeater has a table in which at least either of a public key or watermark information is registered in advance, corresponding to the mail receiver, generates an other attached file by enciphering the attached file using the public key or by putting an electronic watermark into the attached file using the watermark information, and stores the other attached file in a file server and, in response to an access to the attached file from the mail receiver, the file server permits the mail receiver to refer to the other attached file.

10. An e-mail relay method, comprising the steps of:
when a file is attached to a first e-mail from a sender side mail server, setting an access permission to an attached file based on information included in the first e-mail; storing the attached file in a file server;
deleting the attached file from the first e-mail;
forming a second e-mail by adding reference information for accessing the attached file stored in the file server to the first e-mail from which the attached file was deleted;
transmitting the second e-mail to a receiver side mail server and the sender side mail server; and,
in response to an access request to the attached file based on the reference information from either of a mail sender or a mail receiver, controlling the access to the attached file based on the access permission.

11. The e-mail relay method according to claim 10, wherein, based on information that is included in the first e-mail and specifies each of the mail sender of the first e-mail and the mail receiver of the second e-mail, a different access permission is set for each of the mail sender and the mail receiver.

12. The e-mail relay method according to claim 11, wherein the access permission being set for the mail sender is a permission for the mail sender to update the attached file.

13. The e-mail relay method according to claim 12, wherein, when the mail sender updated the attached file, the mail receiver of the second e-mail is notified that the attached file has been updated.

14. The e-mail relay method according to claim 11, wherein, in response to forwarding of the second e-mail to another user by the mail receiver of the second e-mail, the access permission to the attached file is set for the other user based on information for specifying the other user included in the second e-mail.

15. The e-mail relay method according to claim 14, wherein, in response to forwarding of the second e-mail from the other user to whom the second e-mail was forwarded to a further other user, the access permission to the attached file is not granted to the further other user included in the second e-mail.

16. The e-mail relay method according to claim 11, wherein the access permission to the attached file is set based on information indicating an access source of either of the mail sender or the mail receiver having made the access request in addition to the information included in the first e-mail.

17. The e-mail relay method according to claim 11, wherein the information included in the first e-mail for determining the access permission to the attached file is information about the mail sender and the mail receiver included in the first e-mail and information included in a text of the first e-mail.

18. The e-mail relay method according to claim 11, characterized by:
maintaining at least either of a public key or watermark information, corresponding to the mail receiver;
forming an other attached file obtained by enciphering the attached file using the public key, or forming the other attached file by putting an electronic watermark into the attached file using the watermark information; and
storing the other attached file in the file server;
wherein, in response to an access to the attached file from the mail receiver, the file server permits the mail receiver to refer to the other attached file.
